(19) United States
(12) Patent Application Publication
(10) Pub. No.: US 2017/0328009 A1
(43) Pub. Date: Nov. 16, 2017

(54) METHOD OF MAKING ROLLED TISSUE PRODUCTS HAVING PRINTED BORDERS

(71) Applicant: Kimberly-Clark Worldwide, Inc., Neenah, WI (US)

(72) Inventors: Timothy Augustine Wooley, Sherwood, WI (US); Gregory James Ryan, Bixby, OK (US); Heidi Ellen Gehrke, Appleton, WI (US); Dennis Patrick Rockhill, Green Bay, WI (US)

(21) Appl. No.: 15/155,241

(22) Filed: May 16, 2016

(51) Int. Cl. D21H 27/00; B41F 17/38; B05D 3/00

(52) U.S. Cl. CPC D21H 27/002; B05D 3/007; B41F 17/38

(57) ABSTRACT

A method of manufacturing rolls of printed tissue includes printing a central pattern on a tissue web to create a central printed lane bordered on each side by unprinted lanes, and further printing distal patterns on the tissue web outward of the unprinted lanes. The tissue is wound into a log, and the log is cut through the central printed lane to produce first and second rolls of tissue, each roll having a proximal end and a distal end, and the cutter contacts ink when cutting the log. First and second printed portions from the central printed lane abut the proximal ends of the first and second rolls of tissue, respectively. Further, the first and second distal printed lanes reside near but do not abut the distal ends of the first and second rolls of tissue, respectively.

### BACKGROUND

Tissue products are often provided in roll form, such as paper towels and toilet paper. Such rolled tissues products are most commonly white. Some consumers enjoy tissue products with visible designs or decorative patterns. Such designs may be delivered to the tissue product via ink, dye, or other technique.

It has been discovered that in the case of certain products, consumers like a decorative design that is flush with at least one edge of the tissue sheet, such as a decorative pattern that is flush with at least one edge of a paper towel. Consumers associate such a design as evoking the character of durable cloth towels, and/or as better coordinating with colors and patterns present in kitchen decor.

One common method of manufacturing rolled tissue products is to print the tissue, to then wind the tissue into a long “log,” usually with a cardboard core therein, and to then slice the log into individual rolls. In existing rolled printed tissue product converting processes, the roll is left unprinted in areas where the log is cut, due to the difficulty in precise cross-direction registration of the wound tissue, and due to the desire to not have partially cut off transversely registered graphics. Printing the entire tissue web is one solution, but such an approach lacks the ability to deliver a towel with graphics tailored to make one or more border regions resemble cloth towels or to properly coordinate with kitchen decor.

Therefore, there is a need for a method of manufacturing rolled tissue products having a flush printed border from long “logs.”

### SUMMARY OF THE INVENTION

The invention is direct to a method of manufacturing rolls of printed tissue, each roll having a roll height. The method includes providing a tissue web having a machine direction and a transverse cross-machine direction. The method further includes printing a central pattern on the tissue web to create a central printed lane extending in the machine direction, the central printed lane having a first edge and a second edge, both parallel to the machine direction, the central printed lane being bordered along the first edge by a first unprinted lane and along the second edge by a second unprinted lane. The central printed lane has a central printed lane width that extends between the first edge and the second edge, and the central printed lane width is less than 1.5 times the roll height. The method further includes printing a first distal pattern on the tissue web to create a first distal printed lane bordered by the first unprinted lane, and printing a second distal pattern on the tissue web to create a second distal printed lane bordered by the second unprinted lane. The method further includes winding the tissue web into a log. The method further includes cutting the log parallel to the machine direction with a cutter through a central cut line to produce first and second rolls of tissue, each roll having a proximal end and a distal end, the central cut line positioned transversely between the first edge and the second edge of the central printed lane, wherein the cutter contacts ink when cutting the log. A first printed portion from the central printed lane abuts the proximal end of the first roll of tissue, and a second printed portion from the central printed lane abuts the proximal end of the second roll of tissue. The first distal printed lane resides near but does not abut the distal end of the first roll of tissue, and the second distal printed lane resides near but does not abut the distal end of the second roll of tissue.

### BRIEF DESCRIPTION OF THE FIGURES

FIGS. 1-3 collectively depict steps of a method of manufacturing rolls of printed tissue according to one embodiment of the invention.

FIG. 1 is a perspective view of several steps of one embodiment of the method of manufacturing of the invention, including printing a tissue web and winding it into a log.

FIG. 2 is a top plan view of a printed tissue log according to one embodiment of the invention.

FIG. 3 is a top plan view of individual rolls of printed tissue cut from the log representatively illustrated in FIG. 2.

FIGS. 4-6 collectively depict steps of a method of manufacturing rolls of printed tissue according to an alternative embodiment of the invention.

FIG. 4 is a perspective view of several steps of an embodiment of the method of manufacturing of the invention, including printing a tissue web and winding it into a log.

FIG. 5 is a top plan view of a printed tissue log according to an alternative embodiment of the invention.

FIG. 6 is a top plan view of individual rolls of printed tissue cut from the log representatively illustrated in FIG. 5.

### DETAILED DESCRIPTION OF THE DRAWINGS

The invention relates to methods of manufacturing rolls of printed tissue, such as paper towels, toilet tissue, or paper napkins. Methods of making such tissue, including wet-laid methods and air-laid methods, are known in the art. Each roll has a roll height 50.

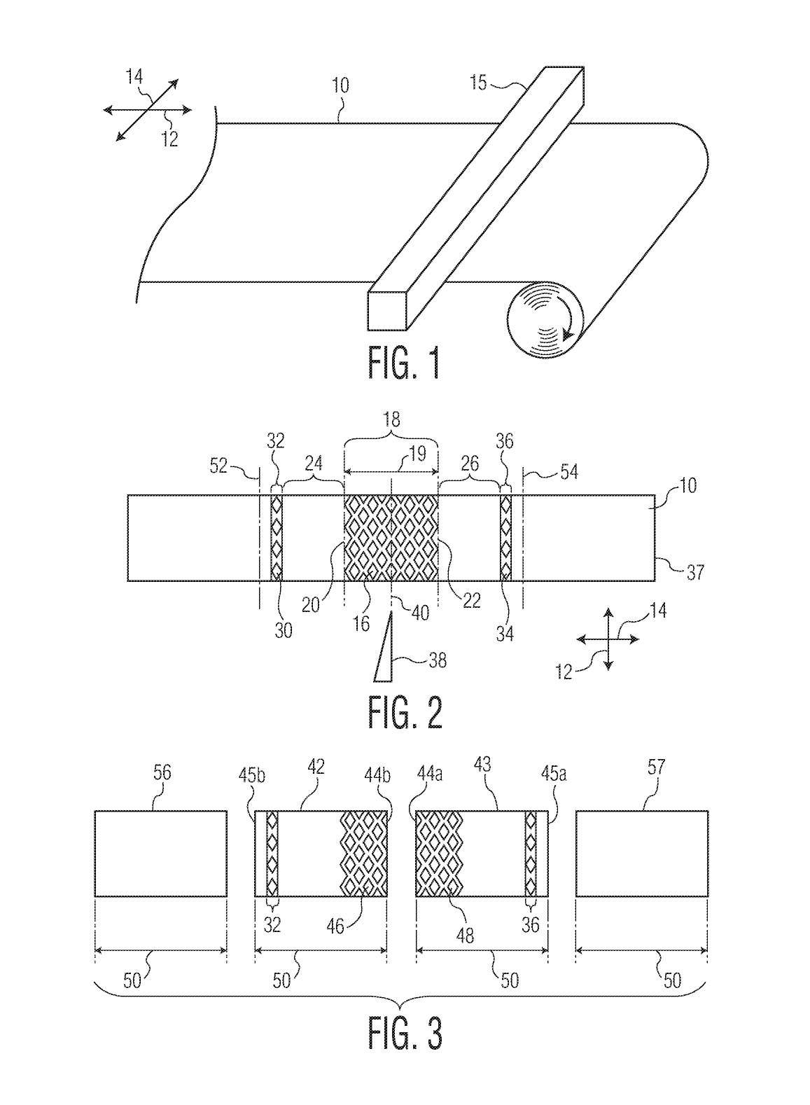

Referring to FIGS. 1-3, in one embodiment, the method includes providing a tissue web 10. The method defines a machine direction 12 and a transverse cross-machine direction 14. The machine direction 12 is parallel to the direction of web travel.

The method in particular embodiments further includes printing a central pattern 16 on the tissue web 10 to create a central printed lane 18 extending in the machine direction 12. In FIG. 2, the central pattern 16 is representatively illustrated as a pattern of diamonds, but any pattern of lines, shapes, or other objects can be used. The central printed lane 18 has a first edge 20 and a second edge 22. Both edges 20, 22 are parallel to the machine direction 12. Each edge 20, 22 is defined by an imaginary straight line that passes through the printed point that is furthest from the central cut line 40 (described below) in the cross-machine direction on respective sides of the central printed lane. The central printed lane 18 is bordered along the first edge 20 by a first unprinted lane 24 and along the second edge 22 by a second unprinted lane 26. The central printed lane 18 has a central printed lane width 19 that extends between the first edge 20 and the second edge 22. In particular embodiments, the central printed lane width 19 is less than 2 times the roll height 50, more particularly less than 1.5 times the roll height, still more particularly less than one roll height, yet more particularly less than 0.75 times the roll height, and still more particularly less than half of one roll height.

The method in particular embodiments further includes printing a first distal pattern 30 on the tissue web 10 to create a first distal printed lane 32 bordered by the first unprinted lane 24, and further includes printing a second distal pattern 34 on the tissue web 10 to create a second distal printed lane 36 bordered by the second unprinted lane 26. In FIG. 2, the distal patterns 30, 34 are representatively illustrated as lines of diamonds, but any pattern of lines, shapes, or other objects can be used.

The method further includes winding the tissue web 10 into a log 37. Winding techniques are known in the art. The method further includes cutting the log 37 parallel to the machine direction 12 with a cutter 38 through a central cut line 40 to produce a first roll of tissue 42 and a second roll of tissue 43. Each roll 42, 43 has a proximal end 44 and a distal end 45. The central cut line 40 is positioned transversely between the first edge 20 and the second edge 22 of the central printed lane 18. The cutter 38 contacts ink when cutting the log 37. In particular embodiments, the method further includes cutting the log 37 along a first distal cut line 52 to define the distal end 45b of the first roll 42, and cutting the log 37 along a second distal cut line 54 to define the distal end 45a of the second roll 43. In particular embodiments, the cut made along the first distal cut line 52 can define a third roll of tissue 56 (depicted in FIG. 3 as unprinted), and/or the cut made along the second distal cut line 54 can define a fourth roll of tissue 57 (depicted in FIG. 3 as unprinted). Suitable cutters for cutting the log at cut lines 40, 52, 54 are known in the art; examples of suitable cutters for cutting tissue logs into individual rolls are known in the art.

In particular embodiments, a first printed portion 46 from the central printed lane 18 abuts the proximal end 44b of the first roll of tissue 42, and a second printed portion 48 from the central printed lane 18 abuts the proximal end 44a of the second roll of tissue 43. “Abuts” means that at least some printed color (e.g., ink) is flush with the relevant end of the roll of tissue. In particular embodiments, the first distal printed lane 32 resides near but does not abut the distal end 45b of the first roll of tissue 42, and the second distal printed lane 36 resides near but does not abut the distal end 45a of the second roll of tissue 43. In particular embodiments, the first distal printed lane 32 is at all points spaced at least one inch from the distal end 45b of the first roll 42, and the second distal printed lane 36 is at all points spaced at least one inch from the distal end 45a of the second roll. Such spacing minimizes the probability that the distal printed lanes 32, 36 will be inadvertently cut by a cutter.

As shown in FIG. 2, in particular embodiments, the central cut line 40 is positioned midway between the first edge 20 and the second edge 22 of the central printed lane 18. In particular embodiments, the first printed portion 46 and the second printed portion 48 are geometrically substantially identical. In other words, they are in particular embodiments geometrical mirror images of each other. In other embodiments, the first printed portion 46 and the second printed portion 48 are not geometrical mirror images of each other (not shown). In particular embodiments, the first printed portion 46 and the second printed portion 48 are mirror images of each other not only in geometry but also in color. In other embodiments, the first printed portion 46 and the second printed portion 48 are mirror images of each other in geometry, but not in color. In particular embodiments, the first distal pattern 30 and the second distal pattern 34 are geometrically substantially identical, but differ in color. In other embodiments, the first distal pattern 30 and the second distal pattern 34 are geometrically substantially identical and are also identical in color. In particular embodiments, a total printed area on the first roll of tissue and a total printed area on the second roll of tissue are the same.

Each pattern is printed using a printer 15. Printing apparatus suitable for use as the printer 15 are known in the art, and include such examples as flexographic printers, ink jet printers, laser printers, rotogravure printers, and other printing apparatuses suitable for printing tissue webs.

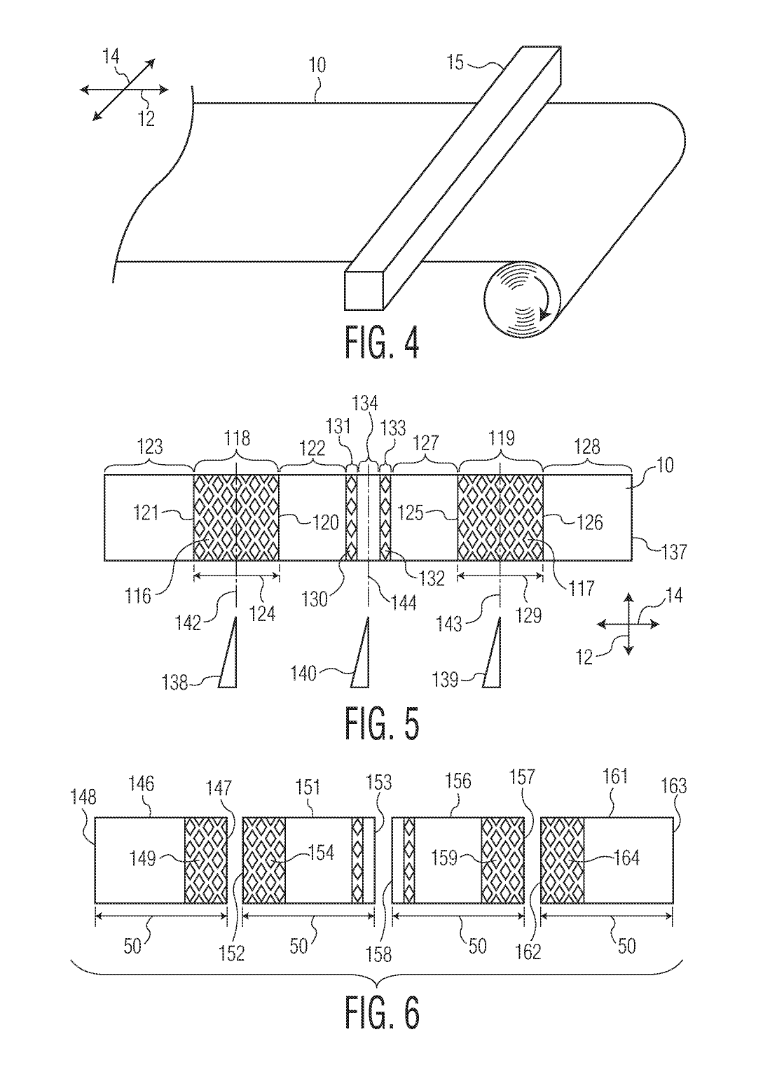

Referring to FIGS. 4-6, in an alternative embodiment, the method includes providing a tissue web 10. The method defines a machine direction 12 and a transverse cross-machine direction 14. The machine direction 12 is parallel to the direction of web travel.

The alternative embodiment of the method further includes printing a first pattern 116 on the tissue web 10 to create a first printed lane 118 extending in the machine direction 12. The first printed lane 118 has a first edge 120 and a second edge 121, both of which are parallel to the machine direction 12. The first printed lane 118 is bordered along the first edge 120 by a first unprinted lane 122, and is bordered along the second edge 121 by a second unprinted lane 123. The first printed lane 118 has a first printed lane width 124 that extends between the first edge 120 and the second edge 121. In particular embodiments, the first printed lane width 124 is less than two times the roll height 50, more particularly less than 1.5 times the roll height, still more particularly less than one roll height, yet more particularly less than 0.75 times the roll height, and still more particularly less than half of one roll height.

The alternative embodiment of the method further includes printing a second pattern 117 on the tissue web 10 to create a second printed lane 119 extending in the machine direction 12. The second printed lane 119 has a third edge 125 and a fourth edge 126, both of which are parallel to the machine direction 12. The second printed lane 119 is bordered along the third edge 125 by a third unprinted lane 127 and along the fourth edge 126 by a fourth unprinted lane 128. The second printed lane 119 has a second printed lane width 129 that extends between the third edge 125 and the fourth edge 126. In particular embodiments, the second printed lane width 129 is less than two times the roll height 50, more particularly less than 1.5 times the roll height, still more particularly less than one roll height, yet more particularly less than 0.75 times the roll height, and still more particularly less than half of one roll height.

The alternative embodiment of the method further includes printing a third pattern 130 to create a third printed lane 131 extending in the machine direction 12, and printing a fourth pattern 132 to create a fourth printed lane 133 extending in the machine direction 12. The third printed lane 131 and the fourth printed lane 133 are each transversely between the first printed lane 118 and the second printed lane 119. The third printed lane 131 is bordered by the first unprinted lane 122 and the fourth printed lane 133 is bordered by the third unprinted lane 127. The third printed lane 131 is separated from the fourth printed lane 133 by a fifth unprinted lane 134.

The embodiment further includes winding the tissue web 10 into a log 137. The method further includes cutting the log 137 parallel to the machine direction 12 with first, second, and third cutters 138, 139, 140 through first, second, and third cut lines 142, 143, 144, respectively, to produce first, second, third, and fourth rolls of tissue 146, 151, 156, 161. The first cut line 142 is positioned in the first printed lane 118, and the first cutter 138 contacts ink when cutting the log 137. The second cut line 143 is positioned in the second printed lane 119, and the second cutter 139 also contacts ink when cutting the log 137. The third cut line 144 is positioned in the fifth unprinted lane 134, and the third cutter 140 does not contact ink when cutting the log 137.

In the embodiment, a first half 149 of the first pattern 116 abuts a first end 147 of the first roll 146. A second half 154 of the first pattern 116 abuts a first end 152 of the second roll 151. A first half 159 of the second pattern 117 abuts a first end 157 of the third roll 156. Finally, a second half 164 of the second pattern 117 abuts a first end 162 of the fourth roll 161.

The first roll 146 has a second end 148, the second roll 151 has a second end 153, the third roll 156 has a second end 158, and the fourth roll 161 has a second end 163. No pattern abuts any second end 148, 153, 158, 163 of any of the first, second, third, and fourth rolls 146, 151, 156, 161.

In particular embodiments of the alternative embodiment, as shown in FIG. 5, the first cut line 142 is positioned midway between the first edge 120 and the second edge 121 of the first printed lane 118, and the second cut line 143 is positioned midway between the third edge 125 and the fourth edge 126 of the second printed lane 119. In particular embodiments, the first and second halves 149, 154 of the first pattern 116 and the first and second halves 159, 164 of the second pattern 117 are all geometrically substantially identical.

Referring to FIG. 6, the first roll of tissue 146 has a first total printed area, the second roll of tissue 151 has a second total printed area, the third roll of tissue 156 has a third total printed area, and the fourth roll of tissue 161 has a fourth total printed area. In particular embodiments, the first total printed area, the second total printed area, the third total printed area, and the fourth total printed area are all equal. In other embodiments, the second total printed area and the third total printed area are equal, but the first total printed area and the fourth total printed area are both different than the second total printed area and the third total printed area.

While the invention has been described in detail with respect to the specific aspects thereof, it will be appreciated that those skilled in the art, upon attaining an understanding of the foregoing, may readily conceive of alterations to, variations of, and equivalents to these aspects. Accordingly, the scope of the present invention should be assessed as that of the appended claims.

What is claimed is:

1. A method of manufacturing rolls of printed tissue, each roll having a roll height, the method comprising the steps of:
providing a tissue web having a machine direction and a transverse cross-machine direction;
printing a central pattern on the tissue web to create a central printed lane extending in the machine direction, the central printed lane having a first edge and a second edge, both parallel to the machine direction, the central printed lane being bordered along the first edge by a first unprinted lane and along the second edge by a second unprinted lane, the central printed lane having a central printed lane width that extends between the first edge and the second edge, wherein the central printed lane width is less than 1.5 times the roll height;
printing a first distal pattern on the tissue web to create a first distal printed lane bordered by the first unprinted lane, and printing a second distal pattern on the tissue web to create a second distal printed lane bordered by the second unprinted lane;
winding the tissue web into a log; and
cutting the log parallel to the machine direction with a cutter through a central cut line to produce first and second rolls of tissue, each roll having a proximal end and a distal end, the central cut line positioned transversely between the first edge and the second edge of the central printed lane, wherein the cutter contacts ink when cutting the log,
wherein a first printed portion from the central printed lane abuts the proximal end of the first roll of tissue, and a second printed portion from the central printed lane abuts the proximal end of the second roll of tissue, and
wherein the first distal printed lane resides near but does not abut the distal end of the first roll of tissue, and the second distal printed lane resides near but does not abut the distal end of the second roll of tissue.

2. The method of manufacturing of claim 1 wherein the central printed lane width is less than half of the roll height.

3. The method of manufacturing of claim 1 wherein the central cut line is positioned midway between the first edge and the second edge of the central printed lane.

4. The method of manufacturing of claim 3 wherein the first printed portion and the second printed portion are geometrically substantially identical.

5. The method of manufacturing of claim 3 wherein the first printed portion and the second printed portion are not geometrical mirror images of each other.

6. The method of manufacturing of claim 4 wherein the first printed portion and the second printed portion are mirror images of each other in color.

7. The method of manufacturing of claim 1 wherein the first distal pattern and the second distal pattern are geometrically substantially identical, but differ in color.

8. The method of manufacturing of claim 1 wherein a total printed area on the first roll of tissue and a total printed area on the second roll of tissue are the same.

9. The method of manufacturing of claim 1 comprising further cutting the log along a first distal cut line to define the distal end of the first roll, and cutting the log along a second distal cut line to define the distal end of the second roll.

10. A method of manufacturing rolls of printed tissue, each roll having a roll height, the method comprising the steps of:
providing a tissue web having a machine direction and a transverse cross-machine direction;
printing a first pattern on the tissue web to create a first printed lane extending in the machine direction, the first printed lane having a first edge and a second edge, both parallel to the machine direction, the first printed lane being bordered along the first edge by a first unprinted lane and along the second edge by a second unprinted lane, the first printed lane having a first printed lane width that extends between the first edge and the second edge, wherein the first printed lane width is less than a roll height;
printing a second pattern on the tissue web to create a second printed lane extending in the machine direction, the second printed lane having a third edge and a fourth edge, both parallel to the machine direction, the second printed lane being bordered along the third edge by a third unprinted lane and along the fourth edge by a fourth unprinted lane, the second printed lane having a second printed lane width that extends between the third edge and the fourth edge, wherein the second printed lane width is less than a roll height;
printing a third pattern to create a third printed lane extending in the machine direction and printing a fourth pattern to create a fourth printed lane extending in the machine direction, wherein the third printed lane and the fourth printed lane are each transversely between the first printed lane and the second printed lane, wherein the third printed lane is bordered by the first unprinted lane and the fourth printed lane is bordered by the third unprinted lane, wherein the third printed lane is separated from the fourth printed lane by a fifth unprinted lane;
winding the tissue web into a log; and
cutting the log parallel to the machine direction with first, second, and third cutters through first, second, and third cut lines, respectively, to produce first, second, third, and fourth rolls of tissue,
the first cut line positioned in the first printed lane, wherein the first cutter contacts ink when cutting the log,
the second cut line positioned in the second printed lane, wherein the second cutter contacts ink when cutting the log,
the third cut line positioned in the fifth unprinted lane, wherein the third cutter does not contact ink when cutting the log,
wherein a first half of the first pattern abuts a first end of the first roll, a second half of the first pattern abuts a first end of the second roll, a first half of the second pattern abuts a first end of the third roll, and a second half of the second pattern abuts a first end of the fourth roll, and
wherein no pattern abuts any second end of any of the first, second, third, and fourth rolls.

11. The method of manufacturing of claim 10, wherein the first cut line is positioned midway between the first edge and the second edge of the first printed lane, and wherein the second cut line is positioned midway between the third edge and the fourth edge of the second printed lane.

12. The method of manufacturing of claim 10 wherein the first and second halves of the first pattern and the first and second halves of the second pattern are all geometrically substantially identical.

13. The method of manufacturing of claim 10 wherein the first roll of tissue has a first total printed area, the second roll of tissue has a second total printed area, the third roll of tissue has a third total printed area, and the fourth roll of tissue has a fourth total printed area, where the first total printed area, the second total printed area, the third total printed area, and the fourth total printed area are all equal.

14. The method of manufacturing of claim 10 wherein the first roll of tissue has a first total printed area, the second roll of tissue has a second total printed area, the third roll of tissue has a third total printed area, and the fourth roll of tissue has a fourth total printed area, where the second total printed area and the third total printed area are equal, and wherein the first total printed area and the fourth total printed area are both different than the second total printed area and the third total printed area.
